(19) United States
(12) Patent Application Publication
(10) Pub. No.: US 2001/0039526 A1
(43) Pub. Date: Nov. 8, 2001

(54) Securities grading system

(76) Inventor: Robert C. Pittenger, Omaha, NE (US)

Correspondence Address: Steven J. Henry, Wolf, Greenfield & Sacks, P.C., 600 Atlantic Avenue, Boston, MA, 02210, US

(21) Appl. No.: 09/810,643

(22) Filed: Mar. 16, 2001

Related U.S. Application Data
(60) Provisional application No. 60/190,470, filed on Mar. 17, 2000.

(51) Int. Cl. G06F 17/60

(52) U.S. Cl. 705/36

(57) ABSTRACT

A system and method for categorizing (i.e., grading) securities based on a combination of the market performance of the security and the commercial, business performance of the issuer of that stock.

### FIELD OF THE INVENTION

This invention relates to the field of investment decision-making and, in particular, to an investment decision support system that evaluates and categorizes corporate securities, such as stocks, of publicly-held companies.

### BACKGROUND OF THE INVENTION

On United States exchanges alone, the stocks of over 14,000 publicly-traded companies are bought and sold daily. Investors, whether they be individuals or institutions, face a formidable challenge in analyzing the enormous quantity of data available regarding these many thousands of potential investment opportunities, to determine which stocks meet their investment criteria. Often, investors turn to analysts for evaluations of particular stocks. Investment analysts ferret out company and industry performance information and sometimes employ so-called “technical” approaches to forecasting stock performance, based upon calculating mathematical measurements or analyzing the historical performance of a stock and looking for certain patterns. For example, certain stocks are cyclical. Analysts and investors may focus on the underlying strength and characteristics of the business, such as its profitability (earnings) and the relationship between stock price and earnings (e.g., price-to-earnings ratio, P/E), P/E ratio relative to other companies in the same market sector, volume of orders booked, revenue growth rate, debt-to-equity ratio, and so forth. While all of these individual factors and approaches are useful to varying degrees, it is difficult for the average investor—and even some analysts—to interpret such measures and to make meaningful investment decisions based on them. Moreover, a stock's performance on a stock market exchange and the issuing company's business performance are not necessarily inherently linked in a simple manner. Thus, for example, studying a company's financial statements will not tell an investor whether the market sector in which that company is identified happens to be an in-favor or out-of-favor market sector. Neither will studying a company's stock performance tell an investor whether the connection between the company's sales and profitability, on the one hand, and its stock price, on the other, is well-correlated or not.

A need thus exists for a simple way to portray a stock's characteristics to an investor or potential investor.

### SUMMARY OF THE INVENTION

This need is addressed by the present invention, which provides a system and method for categorizing (i.e., grading) stocks based on a combination of the market performance of the stock and the commercial, business performance of the issuer of that stock. Stocks are grouped according to their performance characteristics and their issuers' business performance characteristics, and each such group of stocks is graded. For familiarity, a grading scale of A through F (or A+ through F) may be used, with the most rigorous criteria applied to both business performance and stock performance to merit a grade of “A” or “A+” and with the poorest business and stock performance meriting a grade of “F”. Of course, other grading scales may be employed, such as a scale assigning a grade of 0 through 10, or some other numerical or non-numerical rating scale.

Preferably, the system includes a site or database on the global Internet which may be addressed by interested parties. The interested party may issue a query identifying a stock by its trading symbol or company name and a message will be returned with the grade assigned to that stock. If the accessed site is a web site on the world wide web, the site may also be provided with a page explaining the stock grading criteria or a link to an explanation of the stock grading criteria.

A system according to the invention preferably includes a subsystem for obtaining the company business performance criteria in a substantially automated fashion, via electronic feeds. At this time, there is no one source of financial performance data for all public companies. Thus, if it is desired that the stock of all public companies be graded, or at least the stock of more companies than are covered by any one source of business data, then the data from multiple sources preferably are standardized before being used. This may be done by selecting one source as a reference and conforming information obtained or derived from all other sources to that of the reference source. This may, for example, require that certain data be calculated from the given data.

According to a first aspect, the invention involves a method for grading a security of a publicly traded company, comprising the steps of evaluating the financial, business performance of the company against a pre-determined set of business performance criteria; evaluating the market performance of the security against pre-determined security performance criteria; and assigning to the security a grade based upon the evaluated performances, using predetermined criteria.

According to another aspect, the invention involves a method for grading a security of a publicly traded company, comprising the steps of, at intervals, evaluating the financial, business performance of the company against a pre-determined set of business performance criteria; evaluating the market performance of the security against predetermined security performance criteria; assigning to the security a first grade based upon the evaluated performances, using predetermined criteria; and assigning to the security a second grade based upon a history over time of assigned first grades.

In the foregoing aspects, the security may be a stock.

Yet another aspect of the invention is a system for grading a security of a publicly traded company. A processor means receives from a user an identification of a security for which a grade is requested. Another processor means, responsive to the identification, evaluates the financial, business performance of the company against a predetermined set of business performance criteria. Another processor means, also responsive to the identification, evaluates the market performance of the security against pre-determined security performance criteria. A processor than assigns to the security a grade based upon the evaluated performances, using predetermined criteria.

Additionally, it is an aspect of the invention that there is provided a system for grading a security of a publicly traded company, comprising: means for evaluating, at intervals, the financial, business performance of the company against a pre-determined set of business performance criteria; means for evaluating, at intervals, the market performance of the security against pre-determined security performance criteria; means for assigning to the security, at each of said intervals, a first grade based upon the evaluated performances, using predetermined criteria; and means for assigning to the security a second grade based upon a history over time of assigned first grades.

As noted above, the security may be a stock.

These and other features of the invention will be better understood from the detailed description below, which should be read in conjunction with the accompanying drawings.

### BRIEF DESCRIPTION OF THE DRAWINGS

In the drawing,

FIG. 1 is a picture of an exemplary input screen, such as a user of the world wide web might see on a browser, when addressing a web site to obtain a stock grade in accordance with the invention;

FIG. 2 is a table illustrating an exemplary stock grading system according to the invention, and an exemplary set of criteria for establishing stock grades;

FIG. 3 is a picture of the input screen of FIG. 1 wherein a user has indicated a desire to obtain the grade for the common stock of AT&T Corp, which is assigned the symbol “T”; and

FIG. 4 is a picture of the responsive output screen showing that, using the grading criteria of FIG. 2, AT&T common stock has received a grade of C−.

### DETAILED DESCRIPTION

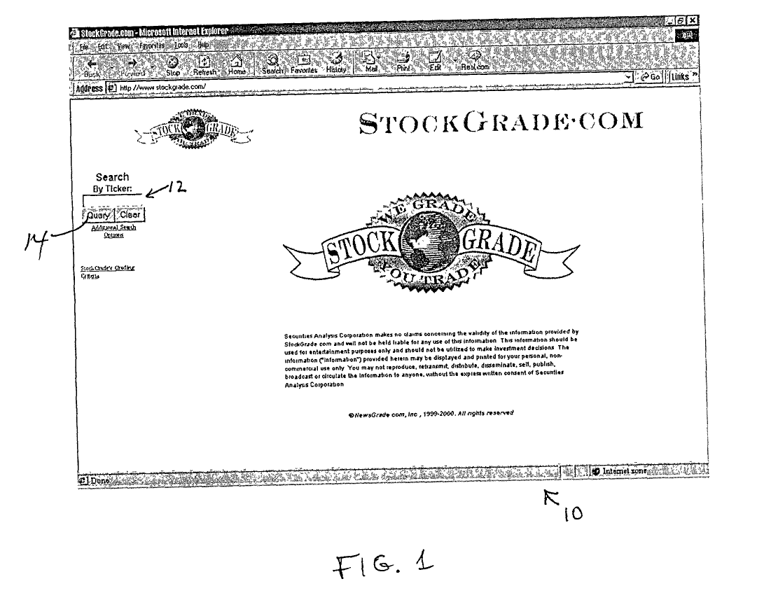

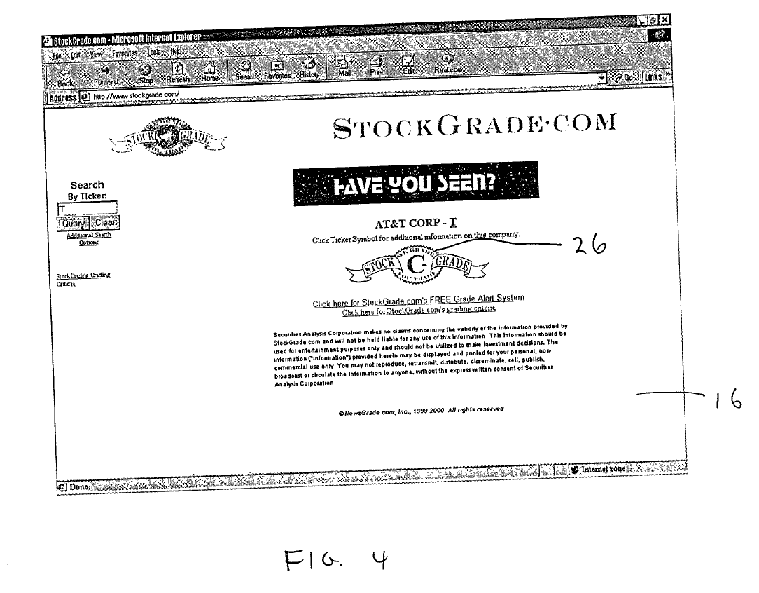

Turning to FIG. 1, there is illustrated an exemplary input screen 10 which may, for example, be displayed by a browser program on a user's client computer which accesses a server computer hosting a world wide web site (or intranet site) to receive from a user a grade query for a security (e.g., stock). The screen 10 has a data input field 12 provided to allow a user to type in an indicator such as a stock name or exchange symbol, following which he or she would then click on the QUERY button 14. That latter action initiates an inquiry to the server computer on which is executed software to obtain a grade for the indicated stock. (The indicated software, of course, may be executed on a computer other than the server, though results would in that case be provided to the server to be served up to the client.) The server (not shown) at the addressed site obtains and delivers for display the grade for the stock. If the stock has previously been graded within a time interval which has been established, and that grade has been stored, then the stored grade may be retrieved and displayed on a screen such as the screen 16 shown in FIG. 4. If the stock grade has not been stored more recently than the established time interval, the grade is computed, displayed and stored. To compute the grade, the appropriate data is retrieved for that stock and the issuing company, and a grading algorithm as taught herein is executed.

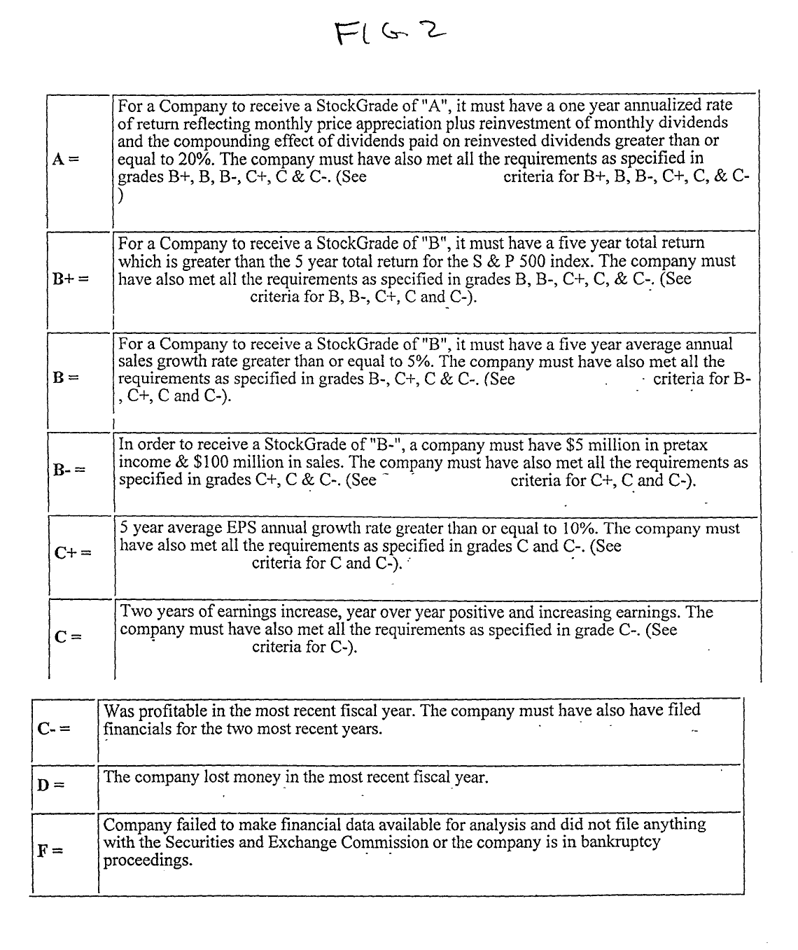

FIG. 2 provides a table which shows exemplary grading criteria using both company financial (business) performance and stock performance to assign a grade to stocks. This, of course, is only an exemplary set of criteria. As shown, the exemplary grading system is designed to favor companies which show consistent historical sales and earnings growth over cyclical companies which have earnings and sales peaks that conform to general economic conditions in their industries. This is a somewhat arbitrary approach to grading stocks and does not imply that the best return on investment or safety of principal is achieved using the illustrated criteria. The criteria used by a grading system will depend on the investment prejudices of the person or group selecting the criteria.

According to the illustrated exemplary grading system, it will be appreciated that a grade of “A” is assigned to companies whose stock has achieved a 1-year annualized rate of return of at least twenty percent. That rate of return includes both overall appreciation of the stock's price and the reinvestment of dividends; where dividends are paid more than once annually, it further includes the compounding effect of reinvesting dividends as they are paid. The company must also have met all of the requirements as specified below for grades B+, B, B−, C+, C, and C−. Of the more than 14,000 companies traded on the N.Y. Stock Exchange, American Stock Exchange, NASDAQ and the OTC Bulletin Board, only about 1.23% would receive a grade of “A” based on these criteria.

A grade of B+ is given to the stocks of companies which have a 5-year total return greater than the 5-year total return for the Standard & Poors (S&P) 500 Index. The stock must also have met all of the requirements for those stocks receiving grades B, B−, C+, C and C−, as specified below. In the same universe of companies, only about 0.95% would receive a grade of B+.

A grade of B is assigned the stock of those companies which have a five-year average annual sales growth rate of at least 5%, provided the stock also has met all the requirements for receiving a grade of B−, C+, C and C−, explained below. For the indicated universe of a 14,000 companies, about 4.11% merit a grade of “B”.

A grade of B− is assigned to stocks of companies having at least $5,000,000 in pre-tax income and $100,000,000 in sales, provided the stock has also met the requirements for receiving grades of C+, C and C−. About 0.71% of the indicated stocks would receive a grade of B−.

A grade of C+ is assigned to those stocks having a 5-year average annual growth rate in earnings per share (EPS) of at least 10%, provided the stock also meets all of the requirements for receiving grades C and C−. Approximately 3.14% of the companies in the indicated sample receive a grade of C+.

A grade of C is assigned to the stocks of companies having two years of earnings increases, with each quarter of the second year having higher earnings than the corresponding quarter in the first year, and all quarters having positive earnings. Of course, the company's stock must also have met all of the requirements for receiving a grade of C−. A grade of C will be merited by approximately 10.21% of the stocks considered in the database.

A grade of C− is assigned to the stocks of companies profitable in the most recent fiscal year, provided the company has also filed financial reports for the two most recent years with an appropriate regulatory authority such as the U.S. Securities and Exchange Commission. Approximately 18.23% of the stocks in the database receive a grade of C.

The stocks of companies that lost money in the most recent fiscal year are assigned a grade of “D”. On a recent review, approximately 34.26% of the stocks in the database received a “D” grade.

The grade of F is assigned to the stock of companies which failed to make major financial data available for analysis and which did not file reports with regulatory authorities, as well as to the stock of companies in bankruptcy proceedings. Approximately 27.16% of the stocks in the database received a grade of “F”.

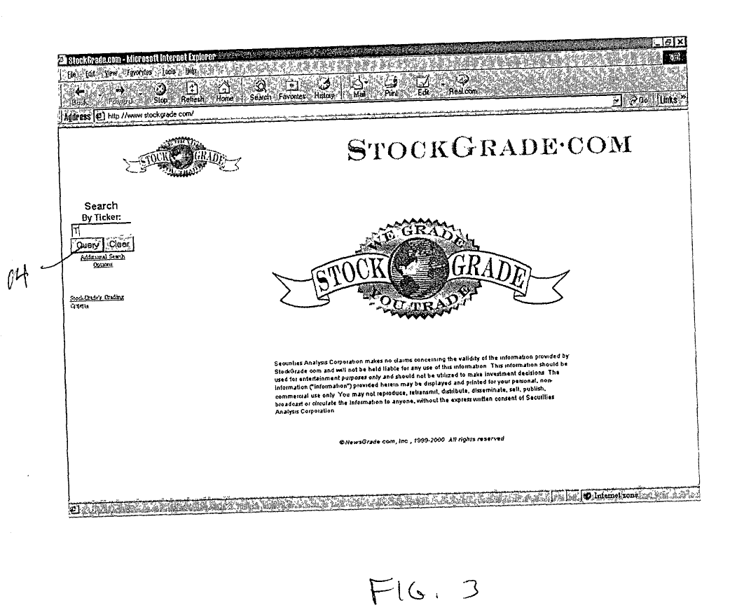

FIGS. 3 and 4 illustrate an exemplary use of a grading system according to the invention. In FIG. 3, a user's browser screen is shown for a computer accessing a world wide web site which provides stock grades based on this system. In the input box 12, the user has provided the letter “T”, which is the symbol for AT&T common stock on the New York Stock Exchange. Once the query button 14 is clicked, the stock grade is retrieved or generated and returned at 26 on a new, output screen shown in FIG. 4. Using the exemplary criteria listed in FIG. 2 and discussed above, AT&T stock has received a grade of C−.

In the US, financial data for about 9500 public companies is available electronically from a division or subsidiary of Standard & Poors. No other service covers a large number of publicly held companies. As there are over 14,000 publicly traded companies, however, other sources must be employed for financial data on the remaining companies. For example, reports on such companies may be obtained from the EDGAR database of the Securities and Exchange Commission, financial reports obtained directly from companies, news services that provide corporate press releases, and so forth. Those various sources do not use a financial reporting format identical to the S&P format, so the company data must be normalized before fair comparisons can be made or the grading criteria applied consistently. With the S&P database covering more than half the publicly traded companies, it preferably is the standard to which other databases are normalized, though other databases could be used as the standard for normalization. Preferably, normalization can be automated in full or in part. Using today's technologies and given today's economics, however, it is envisioned that the data normalization process, while relatively simple, for now can be quite time consuming and labor-intensive. An emphasis should be put on the quality of the data as well as standardizing it to industry norms. While most of this data is available from public records, the collection, sorting and compiling of data on every publicly traded company in the U.S., regardless of size, requires (at this time) human intelligence. A data collection team (for now) preferably continually (i.e., at frequent intervals) updates the required data, while also picking up new filings, and watching for late filings. A company filing late financial reports runs the risk of being downgraded significantly. In addition, companies filing for the first time will be automatically upgraded.

Optionally, means are also provides for a user to register with the web server to monitor a particular stock or stocks. When the grade assigned a monitored stock is changed, an e-mail message is sent to the registrant indicating that the change has occurred.

As a further option and enhancement, electronic new reports may be monitored and when a report is noted for a monitored company or stock, a copy thereof or a message containing a hyperlink to the story may be sent via e-mail to the registrant.

When used herein, the term “means” refers to one or more computers or processors (wherever located) executing appropriate computer program instructions to perform a recited function.

Having thus described an exemplary implementation of the invention, it will be apparent now that stocks (or other securities) may be graded using other multidimensional approaches in which one dimension represents a company's financial performance and another dimension represents the market performance of the stock (security) itself. Optionally, a third dimension may be introduced into the grading system. For example, the third dimension might represent the grades which have been assigned over time using the first two dimensions.

What is claimed is:

1. A method for grading a security of a publicly traded company, comprising the steps of:
a. evaluating the financial, business performance of the company against a pre-determined set of business performance criteria;
b. evaluating the market performance of the security against predetermined security performance criteria; and
c. assigning to the security a grade based upon the evaluated performances, using predetermined criteria:

2. A method for grading a security of a publicly traded company, comprising the steps of, at intervals:
a. evaluating the financial, business performance of the company against a pre-determined set of business performance criteria;
b. evaluating the market performance of the security against predetermined security performance criteria;
c. assigning to the security a first grade based upon the evaluated performances, using predetermined criteria; and
d. assigning tot he security a second grade based upon a history over time of assigned first grades.

3. The method of claim 1 or claim 2 wherein the security is a stock.

4. A system for grading a security of a publicly traded company, comprising:
a. means for receiving an identification of a security for which a grade is requested;
b. means, responsive to the identification, for evaluating the financial, business performance of the company against a predetermined set of business performance criteria;
c. means, also responsive to the identification, for evaluating the market performance of the security against pre-determined security performance criteria; and
d. means for assigning to the security a grade based upon the evaluated performances, using predetermined criteria.

5. A system for grading a security of a publicly traded company, comprising:
a. means for evaluating, at intervals, the financial, business performance of the company against a pre-determined set of business performance criteria;
b. means for evaluating, at intervals, the market performance of the security against pre-determined security performance criteria;
c. means for assigning to the security, at each of said intervals, a first grade based upon the evaluated performances, using predetermined criteria; and
d. means for assigning to the security a second grade based upon a history over time of assigned first grades.

6. The system of claim 4 or claim 5 wherein the security is a stock.
